(19) United States
(12) Patent Application Publication
(10) Pub. No.: US 2005/0172144 A1
(43) Pub. Date: Aug. 4, 2005

(54) Apparatus and method for securely isolating hard disk

(76) Inventor: Tong Shao, Province (CN)

Correspondence Address: Raymond Yat Chan, 1050 Oakdale Lane, Arcadia, CA, 91006, US

(21) Appl. No.: 10/515,567

(22) PCT Filed: Nov. 29, 2002
(86) PCT No.: PCT/CN02/00858

(30) Foreign Application Priority Data
May 20, 2002 (CN) 02113032.9

(51) Int. Cl. H04L 9/00

(52) U.S. Cl. 713/200

(57) ABSTRACT

The invention presents an apparatus and method of realizing secured and compatible partition or absolute separation of multiple sections on a single hard disk for multiple OS as well as other software programs. One-way lockup device and set address lock device together constitute a complete and secured apparatus to separate OS and other software programs on a single hard disk. Furthermore, with hard disk reserved section, write-protection section in the front of hard disk, write-protection section at the back of hard disk, and hard disk Address Offset technology, it can realize secured and compatible absolute separation of multiple OS or software programs on a single hard disk with data exchange or one-way data exchange at the same time.

### BACKGROUND OF THE PRESENT INVENTION

1. Field of Invention

The present invention relates to a secured hard disk partition apparatus and the method thereof, more particularly wherein multiple sections can be compatibly created and absolutely separated on a single hard disk in a security manner.

2. Description of Related Arts

For security purpose, an internal network, such as inter-organization intranet, of a computer system is kept separate from an external network thereof, such as Internet, in order to prevent unwanted information leakage from one network to another. Traditionally, there are two security solutions for that, which are the “single hard disk solution” and the “double hard disk solution”, known in the art for achieving the relevant network security. Double- hard disk solution means to install two hard disks within one computer. When within the Intranet, the computer should be booted with the corresponding hard disk and be connected (or not) to the Intranet; when using the Internet, it should be booted with the corresponding hard disk and be connected to the Internet. Obviously, for the purpose of security, when the Internet (or the Intranet) is booted, hard disk and network connection to the Intranet (or the Internet) is separated absolutely, that is to say, absolutely not available for use or for effective write/read (W/R). In other words, a single computer system to which both of the networks are connected could separately operate the Intranet and the Internet and the information exchange within the Intranet can be effectively kept confidential with respect to the Internet.

Obviously, the double-hard disk solution could realize absolute separation between the Intranet and Internet, but it can only do with two hard disks, which costs comparatively high and cannot have data exchange at the same time. So, single-hard disk solution has come into being as a substitute. For this solution, one hard disk consists of two sections, each with its own operating system (OS, corresponding to either the Intranet or the Internet); then the operator can choose to booting either the internal or external system, or use real time on-line switch computing system, which is included in Chinese pending patents ZL 01115545 and ZL 01117401. As to single-hard disk solution, when the system is connected to the Internet, it should be ensured that the internal area should not be written or read by anyone else (please refer to Chinese patent ZL 94111461); when the system is connected to the Intranet, it should be ensured that the external area should not be written (or not be written and read at best), thus the internal data will not be disclosed to the external; at the same time, multiple OS (of the internal or external) need booting and rebooting. To reboot multiple OS, a method of twice booting (please refer to Chinese patent ZL 97116855) should be good with convenience to recover the system when it collapses, which solves the problem of OS collapse for security management when it happens. All the above applications are combined to the Invention as references. In addition, in single-hard disk solution, if an exchange section is realized on hard disk, which can be written or read when the external system is booted, and readonly when the internal is up, information will be transferred one-way from the external to the internal and there will never be any automatic disclosure of the internal data. Of course, the exchange section can be made written and read to and fro, but the security performance will be reduced. Obviously, passwords and other identity authentication methods can be employed to strengthen the security and realize controllable W/R of the exchange section. Therefore, the safe and flexible data exchange between the internal and external can be realized while information security is guaranteed.

To sum up, the essential of single-hard disk solution is to divide one hard disk into two or more sections for multiple OS; when one of the OS is booted, hard disk sections occupied by other OS should be not written or read (or readonly) as per specific security requirements.

Unlike the “double hard disk solution”, this “single hard disk solution” involves some other problems. Since the effectiveness of the “single hard disk solution” largely depends on effective partitioning and management of the hard disk resources, therefore, in order to achieve secure partitioning and reliable network operation, considerable knowledge and technique for hard disk partitioning and network protection is definitely required. For a layperson or an ordinary network user, this seems to be over-demanding. Moreover, there exist incompatibility problems among multiple operating systems installed in one hard disk due to their competition of scarce hard disk resources. Even there is no incompatibility, certain OS may not capable of supporting ever-advancing hard disk technology so that the “single hard disk solution” cannot be used universally. For instances, if the capacity of a particular hard disk is 40G, and that a first 20G partition and a second 20G partition are intended to be reversed for internal and external networking respectively, such popular OS as WIN 95 does not have the capability to partition such a large capacity hard disk, for WIN 95 cannot be installed to the partition after 8G. To solve this difficulty of WIN 95, an internal network (or an external network) may be obliged to allocate a smaller capacity (about 6G), while the remaining capacity is allocated to the external network (or the internal). Alternatively, the hard disk may need to be divided into a plurality of partitions, wherein multiple OS can be installed as per the above requirements. The former solution is not very flexible, while the latter may become very complicated and expensive to operate for common users.

At an attempt to resolve the above difficulty, an Address Offset method for a hard disk have been developed and disclosed in a granted China patent numbered ZL00132989.8. Nowadays, the hard disk manufacturers have realized that the Address Offset method as well as Address Offset mode was feasible and efficient for initializing multiple OS. However, the current Address Offset techniques and methods are still not mature enough and not yet ready for widespread application. As shown in FIG. 1 of the drawings, a method of changing an OS by Address Offset mode is illustrated. According to the U.S. Pat. No. 6,415,383, after initializing a set of executing orders, such as F8 and F9 (Set Max_Address), the hard disk will be divided into two partitions, namely, a user accessible section LBA (0)-LBA (R), and a user inaccessible section LBA (R)-LBA (M) as shown in FIG. 1. Here, R represents a medium address, and M represents the maximum address of the hard disk. Obviously, if the user accessible section is allocated to the external network partition and the user inaccessible section is allocated to the internal network partition of the hard disk, the computer system running communicated with the external network will not access to the data stored within the internal network address. The user could issue Address Offset command, such as Set Features (EF) (Feature Register Set 09H, then Command Register Set FEH) to enable the Address Offset mode, as shown in FIG. 1. Accordingly, when the computer system was running with internal network, data or commands transmitted by the external network will be inaccessible to the internal network as well. However, the current hard disk standard (ATA 7) has failed to provide a comprehensive coverage to security issues. The user could disable the Address Offset mode by setting a command instruction, such as Feature Register Set 89H, then Command Register Set FEH. Or otherwise, the user could disable the Address Offset mode by soft reset, such as Device Control Register SRST Set. The main reason for this inadequate security strategy has come out of that current hard disk Address Offset standards are drafted out without enough consideration of computer users' great demands for information security in the era of the Internet.

From security perspective, a computer system must prohibit a user from changing the size of the user accessible section and user inaccessible section of a hard disk by unsecured methods, such as F9 command or any other low-security forms of passwords. Furthermore, a computer system must prohibit a user from freely entering or exiting an Address Offset mode of a hard disk. For example, the computer system must prohibit a user from entering or exiting the Address Offset mode by issuing the Command Register Set FEH command or by soft reset method to damage the security of a hard disk. It is noted that exiting the Address Offset mode is equivalent to changing the base address of Address Offset (i.e. the base address of Address Offset R is changed to 0—no changing of Address Offset at all).

Obviously, if the above-mentioned Address Offset method is utilized, as indicated in the standard of ATA 7, there will be no reserved areas at the back of hard disk for normal operation. As such, even though the Address Offset technique could effectively solve the compatibility problem of multiple OS, it would be impossible for hard disk to perform its conventional function. For instance, the extendibility of BIOS function supported by the reserve area, which is still inaccessible, has been sacrificed. The value of R (Set Offset) in FIG. 1 could be understood as a set point of Address Offset.

On the other hand, in a typical conventional computer system, there exist some straightforward commands in order to switch the hard disk between its various modes of operations. For example, the protection of the setting condition of F9 command could be changed by password. At the same time, the soft reset (Device Control Register SRST Set) could reset the hard disk back to the initiative condition, and the hard reset could directly change the set condition of the hard disk by issuing a FEH subcommand 89H to exit the Address Offset mode. However, with regard to partition and security, one-way lockup device should be used to ensure the computer state should be changed only if the computer is powered on, rebooted, or hard disk receives reset signals. That is to say, when one-way lockup device is set, any changes to set state of hard disk cannot work unless the computer is powered on or rebooted, and enter absolutely safe program, such as drivers on BIOS and PCI ROM, and TPM technology of TCPA, etc., and the set state of hard disk should be carried out under control. Under such condition, hackers can be completely prohibited to change safe set state of hard disk.

In order to realize safe partition of single-hard disk in accord with present hard disk interface standards, a one-way lockup device should be adopted to ensure secure separation between hard disk sections. When the device is locked (set), any hard disk command that may go against safe partition strategy of single hard disk solution will be prohibited, while one-way lockup device and the secured hard disk partition device can be between the main board IDE and hard disk IDE interfaces, or within the main-board chipset controlling IDE, or hard disk controller and driver.

Thus, it is desirable to develop a safe hard disk partition device and method that complies with current well-established hard disk standard, such as ATA-7. The isolating device and method should be easily understood for lay computer users, and aims to solve the above-mentioned difficulties of the relevant conventional arts like safe separation of multiple OS, software compatibility and BIOS extension, etc.

### SUMMARY OF THE INVENTION

The main object of the present invention is to provide a hard disk security arrangement that is in compliance with current hard disk standard to compatibly install OS or any other software on a hard disk respectively and to enhance the BIOS extendibility in a security manner. In addition, the present invention puts forward a specific apparatus and method to realize secured hard disk partition, which will employ hard disk access Address Offset apparatus, hard disk Address Offset access method, hard disk W/R protection section, twice booting method and one-way lockup device to solve problems of separation of multiple OS or any other software on a hard disk and software compatibility easily and safely.

On one hand of the invention, in order to accomplish the above object, the present invention provides a hard disk security arrangement for a computer system, comprising:

a one-way lockup device; and

a set address lock devices.

One-way lockup device is a register that can be reset when the computer (or hard disk) is powered on or reset, wherein one-way lockup device locks up a set addresses of the hard disk while set address lock devices prohibits the hard disk from executing any command to change the set address locked by one-way lockup device.

Commonly, as to current hard disk interface standard ATA-7, the commands capable to change hard disk set addresses sent by the computer to hard disk are: Set Max Address (to set the minimum address of W/R protection section at the back of hard disk), subcommands of Set features (89H), and SRST (soft reset), which should be forbidden. In the future, the commands that should be forbidden in the new standard include: Set Behind (to set the minimum address of read-protection section at the back of hard disk), Set Front (to set up the maximum address of W/R protection section in the front of hard disk), and Set Offset (to set the base address of hard disk Address Offset).

Preferably, to put the apparatus realizing secured hard disk partition in hard disk driver, the safe service modes of hard disk commands of Set Max Address and Set features should be changed accordingly for security purpose. With one-way lockup device, when it is set, the set addresses of current hard disk are locked up. According to the state of one-way lockup device, set address lock device will prohibit hard disk to execute any commands able to change hard disk set address. It is worth to mention that the current Address Offset command of the ATA-7 standard should be replaced by the new Set Offset (to set base address of hard disk Address Offset), to prevent the entering or exiting of the Address Offset mode (entering 09H or 89H to features register) by putting FEH into Command register.

Alternatively, the secure hard disk partition device is positioned between hard disk controller and the motherboard IDE interface of the computer system. Once the set address of the hard disk is locked by one-way lockup device, the secure hard disk partition device will block any command from the computer system to change the set address of the hard disk so as to prevent any unwanted change of set address of the hard disk.

Alternatively, the secure hard disk partition device is located between the hard disk controller and the motherboard IDE interface of the computer system at an external monitoring position. Once the set address of the hard disk is locked by one-way lockup device, the secure hard disk partition device sends a rebooting signal to the computer system while receiving a command request to change the set address of the hard disk, so that such commands can be eventually prohibited. Or otherwise, the secure hard disk partition device sends a reset signal to the hard disk, which should be eliminated by rebooting the computer system to ensure the security thereof.

Conveniently, the secure hard disk partition device is installed into the chipsets, such as south bridge chips administrating IDE interface on the main-board. Once the set address of the hard disk is locked up by one-way lockup device, if the CPU sends out a command to the hard disk to change the set address thereof, the chipsets will block the command to the hard disk to change the set address thereof, so as to ensure the lock of the set address for security reason.

According to the present invention, to solve the secure partition and compatibility of the hard disk, the hard disk is divided into two partitions by issuing a Set Max_Address command, namely, user accessible and user inaccessible sections. Meanwhile, the Address Offset techniques complied with the current hard disk standard ATA-7 enable the computer system use these two sections separately. Finally, by incorporating one-way lockup and set address lock device, different OS installed are absolutely isolated in separated sections on the hard disk.

Preferably, the hard disk is divided into multiple sections of a user accessible section, a user inaccessible section, user readonly section, and the base address of hard disk Address Offset. With new means, the addresses of those sections will be set conveniently. Finally, by incorporating one-way lockup device and set address lock, different OS installed on the hard disk are absolutely isolated and the security of hard disk data ensured.

Furthermore, the secure hard disk partition device can be integrally built-in with the hard disk. To incorporating with the network isolation, a signal line communicating with the hard disk is adapted to indicate the security state of the hard disk (internal or external network) and to drive the network selection procedure. Of course, such external device could be directly set by the command send out from the hard disk so as to pave the way for other purposes.

Certainly, the secure hard disk partition device according to the present invention could be comply with different standards of interfaces of hard disks, for example, IDE standard, ATA standard, SATA standard, and the SCSI hard disk.

On the other hand of the Invention, an apparatus integrating the Address Offset device of hard disk with hard disk protection section is provided. It comprises:

a reserving device, executing the command of Set Max Address, which means set minimum address of W/R protection section at the back of hard disk, to protect the security of data at the back of hard disk, that is, W/R protection, referring to FIG. 4-1;

an Address Offset device, executing the command of Set Offset, which means set base address of hard disk Address Offset, to protect the security of data in the front of hard disk, that is, W/R protection, and provide software compatibility, referring to FIG. 4-2;

a write-protection device (readonly) at the back of hard disk, executing the command of Set Behind, which means set minimum address of write-protection section at the back of hard disk for the security of the data of that section at the back of hard disk, referring to FIG. 4-3;

a write-protection device (readonly) in the front of hard disk, executing the command of Set Front, which means set maximum address of write-protection section in the front of hard disk for the security of the data of that section in the front of hard disk, referring to FIG. 4-4;

a one-way lockup device; and

a set address lock device;

wherein one-way lockup device is a register that can be reset when the computer is powered on, or reset, or an apparatus that the state can be changed with a mechanical switch. When one-way lockup device is set, the currently hard disk set address is locked up. According to the set state of one-way lockup device, set address lock device will prohibit hard disk to carry out any commands that can change set state of hard disk set address, namely, those of hard disk reserved section, hard disk Address Offset, write-protection section at the back of hard disk, and write-protection section in the front of hard disk.

Practically, after the computer system is rebooted, the entire hard disk is made readonly, or otherwise the front section of the hard disk readonly, while the remaining sections are inaccessible. Alternatively, a readable area could be set during the initializing process of the computer system, the readable area is similar with the write protect section positioned in the front of hard disk, while the remaining sections are inaccessible. Only if a password or a command could make hard disk written or read. In such a manner, the Set Address program could be installed into the hard disk, so that obsolete computers can be compatible with such devices while data security is ensured.

More conveniently, all hard disk set addresses can be initially preset at a predetermined booting condition, namely, volatile and nonvolatile modes of hard disk set address. When hard disk set address is in the nonvolatile mode, after the computer is rebooted, the address and function will still be effective and the state of hard disk set address can be changed only by password (or command); when hard disk set address is in the volatile mode, after the computer is rebooted, hard disk set address is in normal hard disk state, that is to say, the address of hard disk reserved section is the maximum hard disk address, the base address of hard disk Address Offset is 0, the address of write-protection section at the back of hard disk the maximum hard disk address, and the write-protection section in the front of hard disk is 0.

Reasonably, there are two methods for lockup the set address on hard disk, namely, password lock device and one-way lockup device. Meanwhile, there existed two types of locking condition, namely, set address reserving condition and set address volatile condition after the computer system is reset or the hardware is reset. Certainly, the priority of one-way lockup device is advanced in comparison with the password lock device. Once one-way lockup device is set, the password lock device will be automatically invalidated, no password could alter the set address on a hard disk.

Furthermore, the present invention also provides a method for securely partitioning a hard disk of a computer system, comprising the steps of:

(a) booting the computer and reset one-way lockup device at the same time;

(b) setting hard disk user accessible section as required;

(c) setting one-way lockup device; and

(d) normally booting OS of the computer system.

Furthermore, a user accessible section should be set in following steps: to set the addresses, or any address combinations of hard disk reserved section device, hard disk Address Offset device, write-protection section at the back of hard disk, and write-protection section in the front of hard disk, etc.

These and other objectives, features, and advantages of the present invention will become apparent from the following detailed description, the accompanying drawings, and the appended claims.

### BRIEF DESCRIPTION OF THE DRAWINGS

FIG. 1 is a schematic view showing a conventional hard disk is divided into a user accessible section and a user inaccessible section.

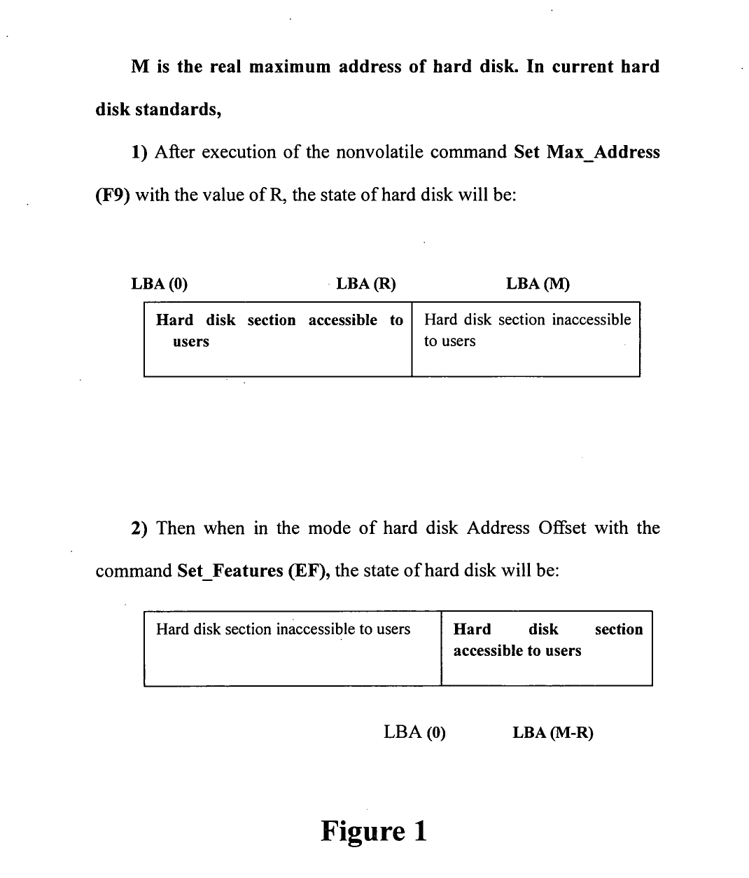

FIG. 2 is a schematic diagram illustrating the hard disk security arrangement within a computer system according to a preferred embodiment of the present invention.

FIG. 3 is an alternative mode of the hard disk security arrangement according to the above-preferred embodiment of the present invention.

FIG. 4 is schematic view showing a Set Max Address command, a Set Offset command, a Set Behind command, and a Set Front command for the set address of the hard disk.

FIG. 5 is a schematic diagram of a hard disk security arrangement according to a second preferred embodiment of the present invention.

FIG. 6 is a schematic diagram illustrating a method for hard disk security arrangement according to the above first preferred embodiment of the present invention.

FIG. 7 is a flow diagram illustrating the method for hard disk security arrangement according to the above first preferred embodiment of the present invention.

FIG. 8 is a detailed flow chart illustrating the hard disk security arrangement according to the above first preferred embodiment of the present invention.

FIG. 9 is a block diagram illustrating the procedures of booting up a computer system incorporating with the hard disk security arrangement according to the above-preferred embodiment of the present invention.

FIG. 10 is an alternative mode of the above booting up procedures of the computer system incorporated with the hard disk security arrangement according to the above first preferred embodiment of the present invention.

### DETAILED DESCRIPTION OF THE PREFERRED EMBODIMENTS

Embodiment Case 1

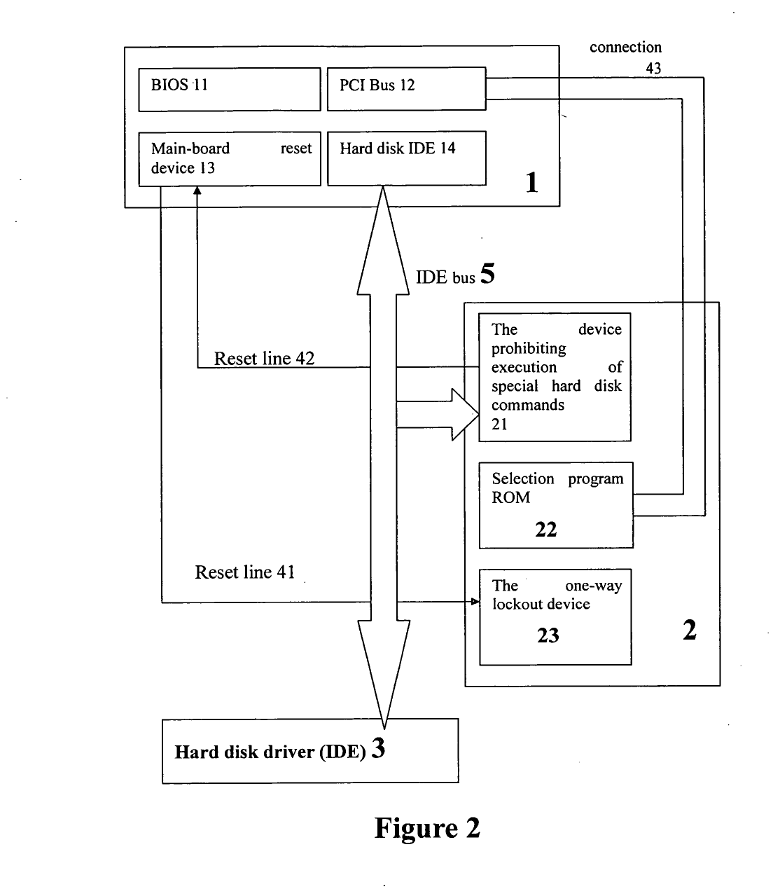

According to Embodiment Case 1 of the Invention, the apparatus realizing secured hard disk partition is showed as FIG. 2, but it is not necessary to have all apparatuses in a lump. 1—the computer main-board; 11—BIOS; 12—PCI Bus; 13—main-board reset device; 14—main-board IDE interface; 2—secured hard disk partition device; 21—set address lock device; 22—ROM storing user selection program; 23—one-way lockup device; 3—hard disk driver (IDE interface); 41—connection of main-board reset device 13 to one-way lockup device 23; 42—connection of set address lock device 21 of the secured hard disk partition device to main-board reset device 13; 43—connection of main-board PCI Bus 12 to the user selection program ROM 22 of the secured hard disk partition device 2; IDE bus 5 connects hard disk driver 3 to the secured hard disk partition device 2. When the computer is powered on or restarted, the computer will send reset signal and execute BIOS11 program, and at the same time reset one-way lockup device through reset signal wire 41. With BIOS11 program, the computer will enter the user selection program to set hard disk state, or execute user selection program of ROM 22 through PCI Bus 12 and the connecting line 43, and then it will choose to set corresponding hard disk address according to user's decision, or upon identity authentication. For instance, to employ the command of Set Max Address (F9) to set hard disk reserved section, or enter the mode of Address Offset with the function provided by hard disk standards (subcommand of 09H of Set Feature) to protect the security of the data in the front of hard disk (W/R protection) and provide software compatibility. Then, one-way lockup device 23 should be set.

After the computer system is normally operated, when computer main-board 1 sends to hard disk driver 3 the command to change hard disk set address, such as to exit the mode of Address Offset (the subcommand of Set Feature of 89H), or to reset hard disk reserved section and soft reset, that is to set SRST and the register of Device Control, to make hard disk exit the mode of Address Offset. All these commands possible to destroy security strategy reach set address lock device 21 in the secured hard disk partition device 2 via IDE bus 5. According to set state of one-way lockup device 23, set address lock device 21 will send reset signal to the main-board reset device 13 to restart the computer and ensure that hard disk set address can not be changed illegally. This embodiment Case only employs additional devices to realize secured hard disk partition without changing current hard disk standard of ATA-7.

It is noted in the first embodiment, the PCI Bus 12 and the user selection program ROM 22 are not absolutely necessary, the selection program could be integrated into BOIS 11 program. In addition, once the computer system sends out a command to change hard disk set address, the set address lock device 21 could keep resetting the hard disk 3 to prevent any changes to the set address, afterwards, the computer system could be safely rebooted. Conclusively, the above procedures all require rebooting the computer system. Even rebooting process is a safe practice, however, it is inconvenient to some users. Therefore, comes out the following embodiment case.

Embodiment Case 2

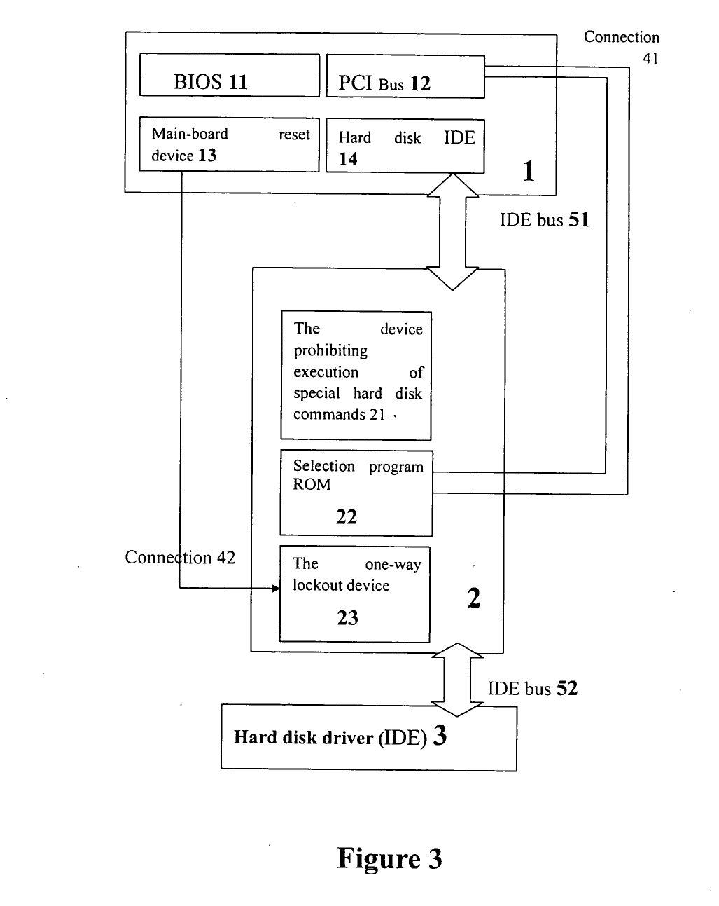

According to Embodiment Case 2 of the Invention, the secured hard disk partition device is indicated as FIG. 3, but it is not necessary to have all apparatuses in a lump. 1—computer main-board; 11—BIOS; 12—PCI Bus; 13—main-board reset device; 14—main-board IDE interface; 2—the secured hard disk partition device; 21—set address lock device; 22—ROM storing user selection program; 23—one-way lockup device; 3—hard disk driver (IDE interface); 41—connection of main-board PCI Bus 12 to selection program ROM 22 of the secured hard disk partition device 2; 42—connection of main-board reset device 13 to one-way lockup device 23 of the secured hard disk partition device 2; IDE bus 51 connects the main-board to the secured hard disk partition device; IDE bus 52 connects the secured hard disk partition device to hard disk driver. After the computer is powered on or rebooted, the computer will send out reset signal and execute BIOS11 program, and at the same time reset one-way lockup device 23 via reset signal line 42. Via BIOS11 program, the computer will carry on the selection program of hard disk set state, or execute selection program of ROM22 via PCI Bus 12 and connecting line 43. Then it will choose to set corresponding hard disk address according to user and(or) by upon identity authentication. For instance, to employ the command of Set Max Address (F9) to set hard disk reserved section, or enter the mode of Address Offset with the function provided by hard disk standards (subcommand of 09H of Set Feature) to protect the security of the data in the front of hard disk (W/R protection) with software compatibility. Then, one-way lockup device 23 should be set.

After the computer system is normally operated, once computer main-board 1 sends to hard disk driver 3 the command to change hard disk set address, such as to exit the mode of Address Offset (the subcommand of Set Feature of 89H), or to reset hard disk reserved section and soft reset (to set SRST and the register of Device Control) to make hard disk exit the mode of Address Offset. All these commands possible to destroy security principles reach set address lock device 21 in the secured hard disk partition device 2 via IDE bus 51. According to the set state of one-way lockup device 23, set address lock device 21 will not transfer the command to hard disk driver 3 via IDE 52, thus, hard disk driver can not receive the command and hard disk set address cannot be changed illegally. As for commands other than that of change of hard disk set address, set address lock device 21 will transfer the command to hard disk driver 3 via IDE 52. This embodiment Case only employs additional devices to realize secured hard disk partition without changing current hard disk standard of ATA-7.

Apparently, in Embodiment Case 2, PCI Bus 12 and selection program ROM22 are not essential; it will also do all right with the selection program being put into BOIS11. It can be realized in several ways to prohibit or transfer hard disk commands, referring to the above-mentioned patents.

It is worth to mention that all devices of the embodiment could be integrally collected on the motherboard IDE interface 14, or collected on the hard disk 3.

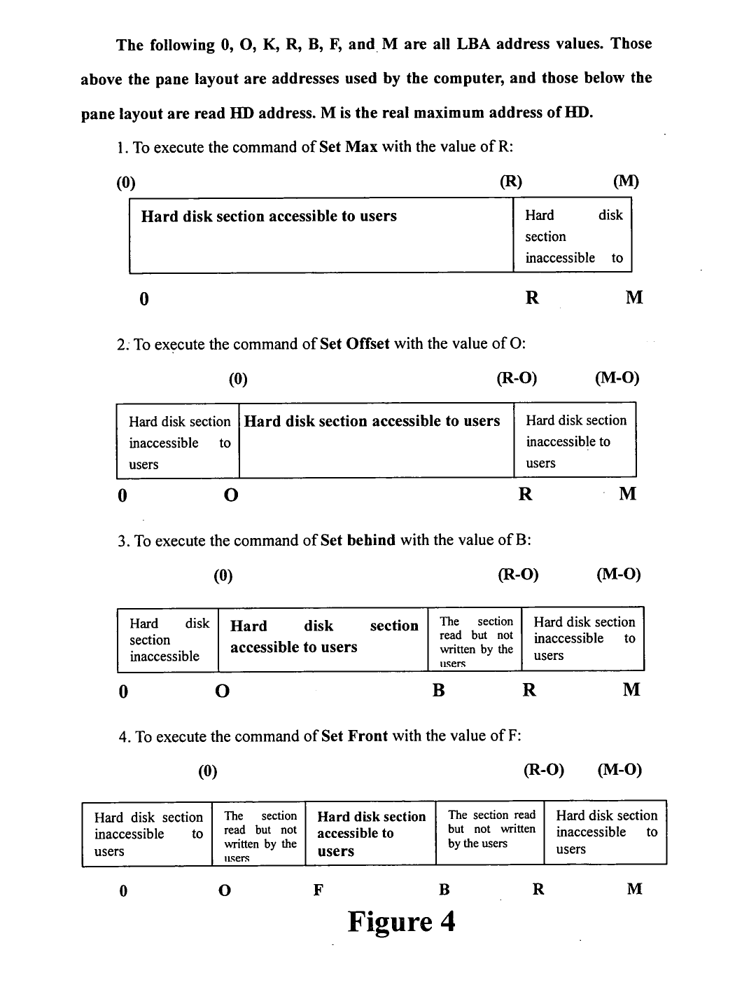

On the other hand, according to a granted Chinese patent ZL94111461 disclosed by the inventor of the present invention, a term ‘track group’ has been disclosed, which indicates a hard disk section between two hard disk addresses. In the claim of Rights 6 of the granted patent, a track group that can be realized with one address is stated. Here, three special track groups can make up of different protection sections, such as hard disk reserved section, write-protection section at the back of hard disk and write-protection section in the front of hard disk. As for the secured protection devices of these protection sections, please refer to the stated patents. As shown in FIG. 4, supposing M is the real maximum hard disk address, 0, O, K, R, B, F and M are LBA (logical block address) address values of hard disk, by all appearances, only the maximum user access address on hard disk needs to be set for hard disk reserved section, which agrees with current hard disk ATA interface standards. It creates a W/R protection hard disk reserved section [see FIG. 4(1)], executing the command of Set Max with the value of R, and enables W/R in the section from 0 to R on hard disk, but not from R to M on hard disk.

To solve the software compatibility, a desirable approach is the hard disk Address Offset techniques disclosed in a granted Chinese patent ZL00132989 of the inventor of the present invention. After executing the command of Set Offset with the value of O, all hard disk commands of W/R will add the value of O to the hard disk address of W/R as the real hard disk address of W/R, and will compare the real address with the value of R as the discriminating address of the reserved section. Therefore, the command enables the computer to read and write the sections between the real addresses from O to R on hard disk (virtual hard disk sections from 0 to R-O), but not to do the same in other sections. Thus, hard disk Address Offset technology can be realized in a natural and understandable way instead of that of ATA-7.

Similarly, it is understandable that the write-protection section at the back of hard disk generally agrees with hard disk reserved section. The difference is that it executes write-protection, but not read-protection. For example, in FIG. 4(3), after execution of Set Behind with the value of B, the computer cannot write the section between the real addresses from B to M on hard disk.

Similarly, it is understandable that the write-protection section in the front of hard disk generally agrees with hard disk reserved section. The difference is that it executes write-protection but not read-protection. For example, in FIG. 4(4), after execution of Set Front with the value of F, the computer cannot write the section between the real addresses from 0 to F on hard disk.

Conclusively, there is a need to combine the above-stated reserved section, hard disk Address Offset device, and secured hard disk partition device (one-way lockup device and set address lock device) for blocking any change to the set address, as well as replace the Address Offset command of the current ATA-7 standard. Therefore, the following embodiment case can come out as a result.

Embodiment Case 3

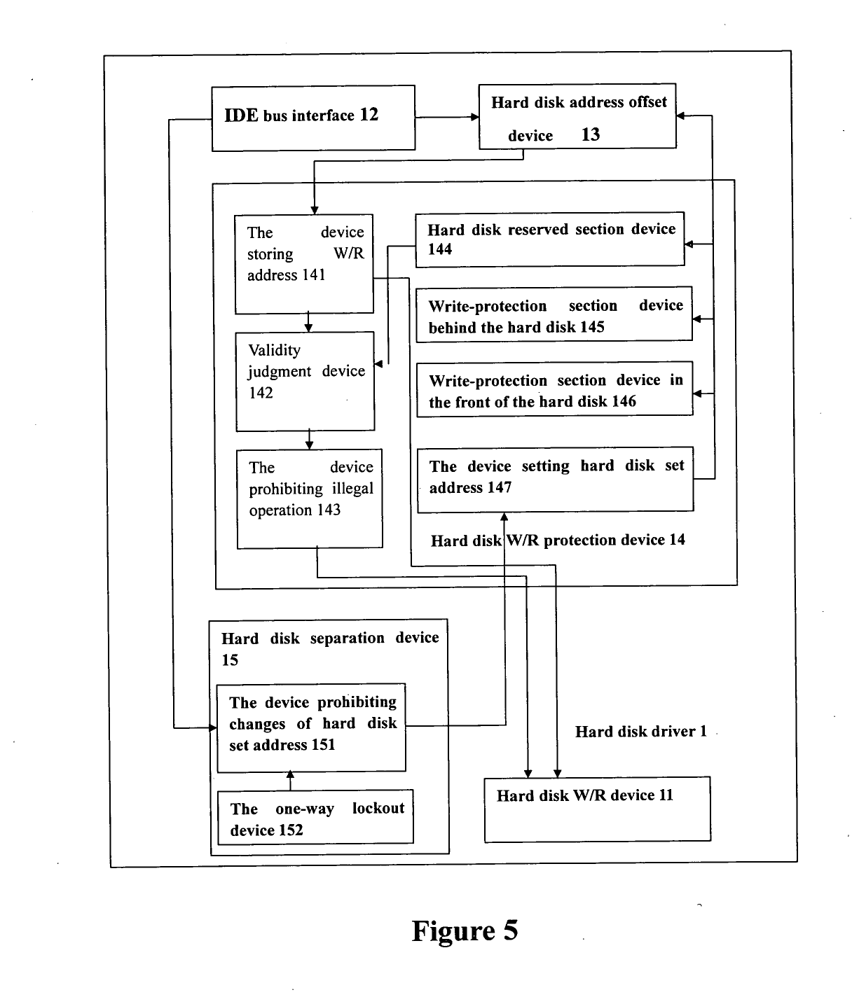

According to Embodiment Case 3 of the Invention, the secured hard disk partition device is indicated as FIG. 5, and the stated device is integrated with hard disk driver. 1—hard disk driver with secured hard disk partition device, Address Offset device of hard disk and hard disk W/R protection device; 11—hard disk W/R device; 12—IDE bus interface of hard disk; 13—Address Offset device of hard disk; 14—hard disk W/R protection device; 15—secured hard disk partition device; 141—the device storing hard disk W/R address; 142—validity judgment device; 143—illegal operation prohibition device; 144—hard disk reserved section device; 145—write-protection section device at the back of hard disk; 146—write-protection section device in the front of hard disk; 147—hard disk set address device; 151—set address lock device; 152—one-way lockup device.

Therewith, hard disk IDE bus interface 12 connects to the Address Offset device of hard disk 13 and secured hard disk partition device 15; the Address Offset device of hard disk 13 to W/R address memory (register) device 141 and hard disk set address device 147; the reserved section device of hard disk 144, reserved section device at the back of hard disk 145 and reserved section in the front of hard disk 146 to hard disk set address device 147 and validity judgment device; illegal operation prohibition device 143 to validity judgment device 142 and hard disk W/R device 11; one-way lockup device 152 to set address lock device of 151; set address lock device of 151 to hard disk set address device 147 and IDE bus interface 12; W/R address memory device 141 connects to the Address Offset device of hard disk 13 and hard disk W/R device 11.

When hard disk driver is powered on or reset through hardware, hard disk driver 1 will reset one-way lockup device 152 with the reset signal, hard disk driver receives hard disk set address command through IDE bus interface. When one-way lockup device 152 is in the state of reset, set address lock device 151 will set the following via hard disk set address device 147: base address of hard disk Address Offset (O), address of reserved area of hard disk (R), address of the reserved section at the back of hard disk (B) and address of the reserved section in the front of hard disk (F). Then, hard disk driver will receive commands to set one-way lockup device 152 via IDE bus interface 12.

When hard disk driver receives hard disk W/R commands via IDE bus interface 12, it will, adding W/R address to O—the base address of hard disk Address Offset via the Address Offset device of hard disk 13, create the real hard disk W/R address, and then put it into the W/R address memory device 141. Validity judgment device 142 will judge whether the W/R operations are legal by the address in W/R address memory device 141, address of reserved area of hard disk (R), address of write-protection section at the back of hard disk (B), and address of protection section in the front of hard disk (F); if legal, the device prohibiting illegal operation 143 will allow hard disk W/R device 11 to write and read hard disk as per the address of W/R address memory device 141, and also receive data (write) or returns data (read) through IDE bus interface 12; if illegal, the device 143 will prohibit hard disk W/R device 11 to write or read hard disk.

When hard disk driver receives commands to change hard disk set address via IDE bus interface 12, such as exiting the mode of hard disk Address Offset, reset hard disk reserved section and soft reset to make hard disk exit the mode of Address Offset, set address lock device 151 will prohibit hard disk set address device 147 to execute changes according to the set state of one-way lockup device 152, including the base address of the Address Offset device of hard disk (O), address of the reserved section device of hard disk (R), address of the write-protection section at the back of hard disk (B) and address of the protection section in the front of hard disk (F). Accordingly, the present invention further comprises a device to change the base address of the Address Offset device.

It should be noted that one-way lockup device 152 be a signal line out of hard disk driver. When the line is in some state (high voltage +5V, equal to the set state of device 151), set address lock device 151 will prohibit hard disk set address device 147 to execute changes of base address of hard disk Address Offset unit (O), address of hard disk reserved section unit (R), address of write-protection section at the back of hard disk (B) and address of write-protection section in the front of hard disk (F); when the line is in another state (low voltage OV), hard disk set address can be changed. Obviously, the locked part of one-way lockup device that can be somewhere outside hard disk driver works together with the other part within hard disk driver to be a complete secured hard disk partition device. Of course, the signal line to set one-way lockup device can be done with a mechanical device.

In the above three embodiment Cases, soft reset (Device Control register SRST set) is the method to exit Address Offset in current hard disk standard, which should be prohibited. However, soft reset has other important functions independent of security. Therefore, it is desirable to wipe off only its security involved function, while maintains its other security unrelated functions. So that the hard disk set address changing prohibitive unit will not prohibit the soft reset command, the hard disk still normally perform the soft reset function.

Embodiment Case 4

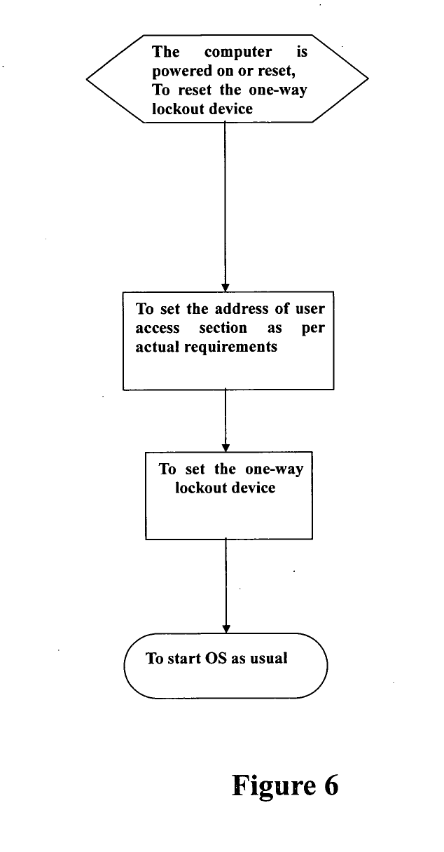

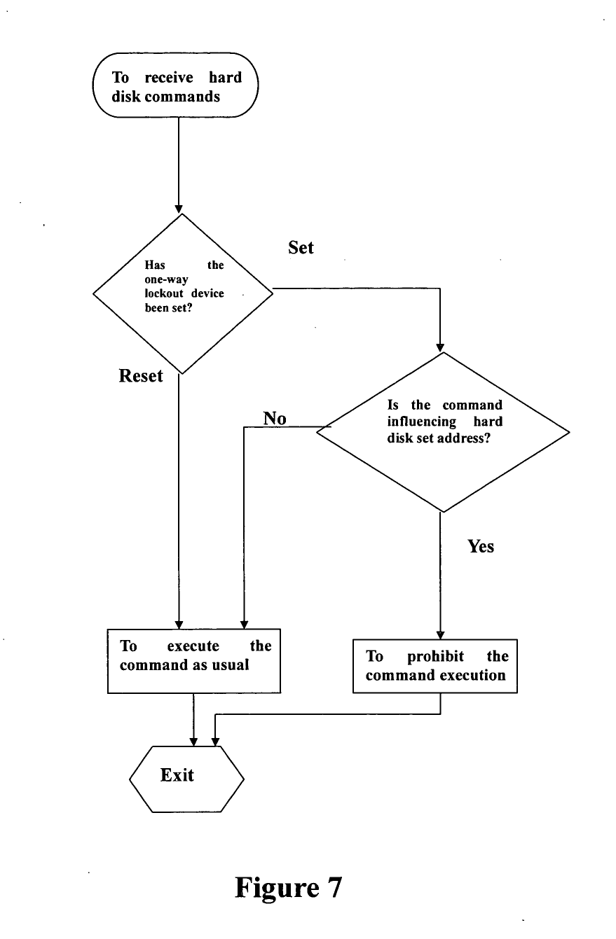

FIG. 6 and FIG. 7 show the flow chart of a method realizing secured hard disk partition according to an embodiment case of the Invention. As shown in FIG. 6, the method comprises the following steps.

(1) Reset one-way lockup device when the computer system is booted;

(2) Selectively set a user accessible section on the hard disk;

(3) Set one-way lockup device to lock up a set address of the hard disk.

(4) Normally boot OS of the computer.

As shown in FIG. 7, once the partition device receives a command transferred from computer, it will first check whether one-way lockup device is set. If one-way lockup device is reset, all commands passed to the hard disk will be normally carried out. If one-way lockup device is in a set position, the partition device will check whether the command will affect the set address. If the command does affect the set address, the command will be abort; if not, the command will be normally carried out.

Embodiment Case 5

FIG. 6, 7 and 8 show the flow chart of a method realizing secured hard disk partition according to an embodiment case of the Invention. As shown in FIG. 6, the method comprises the following steps: (1) resuming one-way lockup device when the computer system is booted; (2) selectively setting a user accessible section on the hard disk; (3) setting one-way lockup device to lock up a set address of the hard disk; and (4) normally running an OS of the computer.

Furthermore, the step (2) should be done in following sequence: to set the address of hard disk reserved section device, base address of hard disk Address Offset device, address of write-protection section at the back of hard disk, address of write-protection section in the front of hard disk, etc.

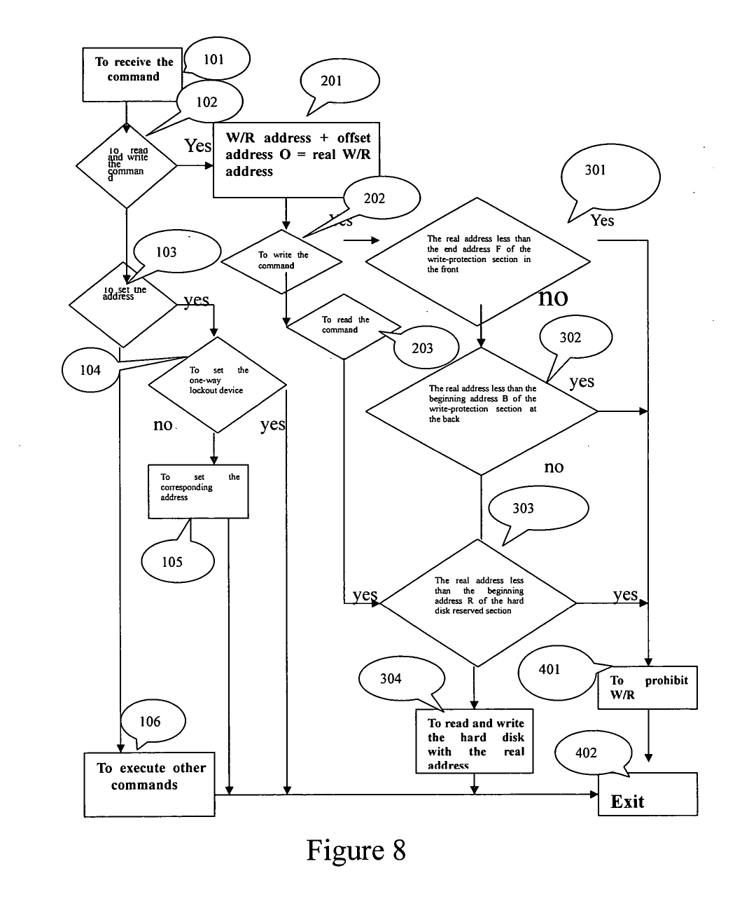

When the set is finished, the secured hard disk partition device in FIG. 8 will receive operation command (101) and judge whether it is W/R command (102). If not, it will further judge whether it is the command of hard disk set address (103); if still not, it should be other command; then the secured hard disk partition device should let hard disk execute the command (106) and then exit (402). If it is the command of hard disk set address, it should judge whether one-way lockup device is set (104); if one-way lockup device is set, it will not execute the operation of set and will exit (402); if one-way lockup device is not set, it will execute the operation of set (105) and then exit (402).

When the secured hard disk partition device receives the operating command (101) and recognize it as W/R command, it will add the address used by the command to the base address O of hard disk Address Offset saved in hard disk Address Offset device 13 (FIG. 5) to get hard disk W/R real address (201), and then judge whether the current operation is write-operation. If yes, it will further judge whether the real address is smaller than the end address F of write-protection section in the front (301), whether the real address is bigger than the beginning address B of the write-protection section at the behind (302), and whether the real address is bigger than beginning address R of hard disk reserved section (303); if yes, it will prohibit W/R (401) and then exit (402); otherwise it will write hard disk with real address (304) and then exit. Accordingly, the present invention further comprises a device to change the beginning address of the write-protection section at the back of the hard disk and a device to change the end address of the write-protection section in the front of the hard disk.

If the current operation is not write-operation, it should be read-operation, it will judge whether the real address is bigger than beginning address R of hard disk reserved section (303). If not bigger, it will read hard disk with the real address (304) and then exit (402); if bigger, it will prohibit hard disk reading (401) and then exit (402). Accordingly, the present invention further comprises a device to change the beginning address of the hard disk reserved section (303).

Embodiment Case 6

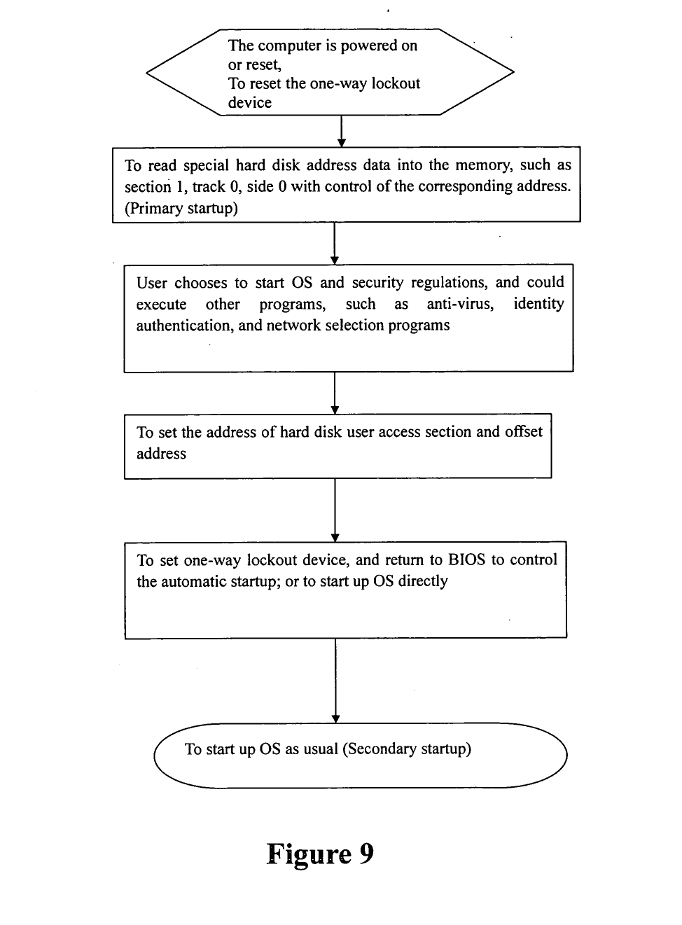

FIG. 9 shows the flow chart of a method realizing secured hard disk partition according to the twice boot embodiment case of the Invention. As shown in FIG. 9, the method comprises the following steps.

(1) Reset one-way lockup device when the computer system is rebooted;

(2) Read special hard disk address data into the memory (such as section 1, track 0, side 0) with control of the corresponding address, named as primary boot;

(3) After self-detection, select an OS and programs to be executed such as virus scanning program, identity authentication program, and network selection program;

(4) Set a user accessible section and base address;

(5) Set one-way lockup device and return to BIOS to control the automatic reboot, or to reboot OS directly; and

(6) Boot OS as usual, named as twice boot.

The main character of the embodiment case is that set hard disk user accessible section and base address of offset address comes really before the reboot of user's OS, including reboots via CD, USB, etc. And also, the program set hard disk user accessible section and base address of offset address is on hard disk. Thus, it provides great flexibility to security set program including anti-virus, identity authentication, and network selection programs. Accordingly, the present invention further comprises an identity authentication device for validating a user's identity so as to prevent unauthorized access to the hard disk.

In addition, every time when rebooted, the computer will first execute programs on hard disk, for example, OS and security regulations with execution of other programs, such as anti-virus, identity authentication, and network selection programs, so when the software (hardware) on hard disk is damaged, equal to the damage of BIOS, and the computer can not be rebooted conveniently. Therefore, the reasonable way is to use a line jumper on the computer main-board to make BIOS choice whether to use the above reboot method. Obviously, such a choice can be connected outside the computer case, which will help to reinstall security programs on hard disk.

When powered on or rebooted, the computer will send out reset signal and enter BIOS program. With the reset signal, it can reset one-way lockup device; and through BIOS, the computer can go into the selection program to set hard disk state; according to user's selection, or after identity authentication, corresponding hard disk state should be selected, and one-way lockup device set. Thus, the partition procedure and identity authentication process have been combined together to achieve a higher secure performance.

Embodiment Case 7

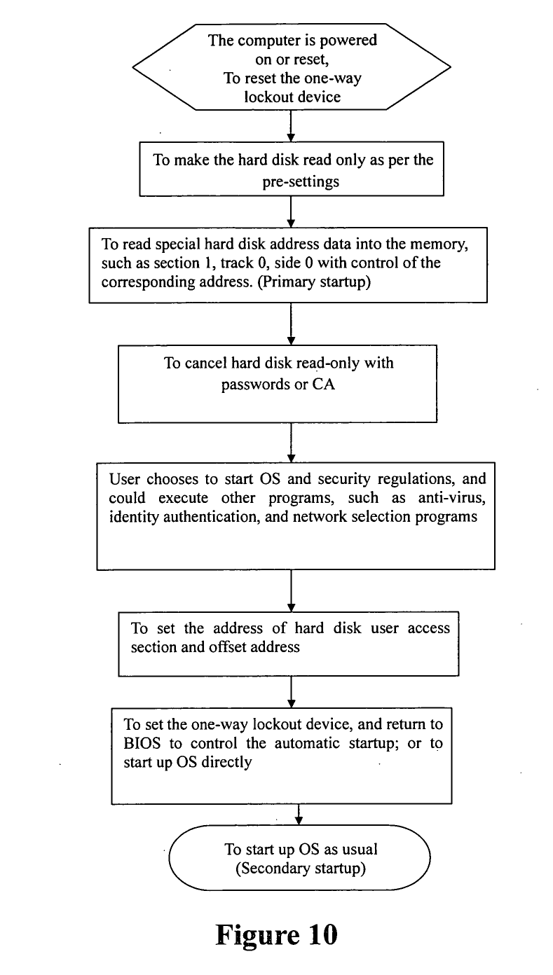

FIG. 10 shows the flow chart of another method realizing secured hard disk partition according to the twice boot embodiment case of the Invention. As shown in FIG. 10, the method comprises the following steps.

(1) Power on or reset the computer and also reset one-way lockup device;

(2) Preset the hard disk to a readonly mode.

(3) Read special hard disk address data into the memory, such as section 1, track 0, side 0, with control of the corresponding address, named as primary boot.

(4) Cancel hard disk readonly with passwords or identity authentication.

(5) Choose OS and security regulations with possible execution of other programs, such as anti-virus, identity authentication, and network selection programs.

(6) Set the address of hard disk user accessible section and base address of offset address.

(7) Set one-way lockup device and return to BIOS to control the automatic reboot, or to reboot OS directly.

(8) Boot OS as usual, named as twice boot.

The character of the embodiment Case is that before the computer changes the W/R protection state of hard disk (Step 4 of Embodiment Case 7) with passwords or identity authentication, the whole hard disk is in the state of W/R protection. Thus, when hard disk is used for an old computer, the security can be increased. When the computer is booted with other medium, such as floppy disk, the security of hard disk data would not be damaged, either.

In the secured hard disk partition device, various addresses need to be organized. As a matter of the fact, all combination of such variety of addresses could be viewed as a whole. In other words, the address combination could be viewed as a kind of hard disk condition. There are two methods to put the unity into the secured hard disk partition device: command method and unity method. Command method means to set a hard disk address once with commands and set address; and the unity method means to set all hard disk addresses with the data of a command transfer address. Obviously, during unity transfer, passwords and other information can be transferred. Command method is equivalent to data transfer of PIO mode in ATA standards, while the unity transfer is equivalent to MULTIWORD transfer and DMA transfer. In addition, many unities can also be formed and a specific unity chosen with selection command or through connecting signal line outside hard disk. Such apparatus and methods to change states of multiple-hard disk can be applied to real-time online switch computer, which can switch protection state of hard disk in a convenient and safe way, referring to Chinese pending patent applications ZL 01115545 and ZL 01117401.

Apparently, one-way lockup device could be substituted by password device and method for more convenience, but lower security performance

One skilled in the art will understand that the embodiment of the present invention as shown in the drawings and described above is exemplary only and not intended to be limiting. It will thus be seen that the objects of the present invention have been fully and effectively accomplished. Its embodiments have been shown and described for the purposes of illustrating the functional and structural principles of the present invention and is subject to change without departure from such principles. Therefore, this invention comprises all modifications encompassed within the spirit and scope of the following claims.

1. An apparatus of realizing secured hard disk partition of a computer, comprising
a one-way lockup device, wherein said one-way lockup device is a register adapted to be reset when said computer is powered on, or reset, or an apparatus that a state is changed with a mechanical switch; and
a set address lock device; wherein when said one-way lockup device is set, said currently hard disk set address is locked up, wherein according to a set state of said one-way lockup device, said set address lock device prohibits said hard disk to carry out any command that changes said set state of said hard disk set address.

2. The partition apparatus, as recited in claim 1, further comprising an Address Offset device, wherein said Address Offset device of said hard disk guarantees a security of data in W/R protection section in the front of said hard disk and provides software compatibility, wherein a base address of said hard disk Address Offset belongs to a set address of said hard disk.

3. The partition apparatus, as recited in claim 1, further comprising a reserved section device of hard disk to guarantee said security of data in W/R protection section at the back of said hard disk, wherein the beginning address of said hard disk reserved section belongs to said set address of said hard disk.

4. The partition apparatus, as recited in claim 1, further comprising a write-protection section device in the back of hard disk to guarantee said security of data therein, wherein the beginning address of said write-protection section in the back of said hard disk belongs to said set address of said hard disk.

5. The partition apparatus, as recited in claim 1, further comprising a write-protection section device in the front of hard disk to guarantee said security of data therein, wherein the end address of said write-protection section in the front of hard disk belongs to said set address of said hard disk.

6. The partition apparatus, as recited in claim 2, further comprising a device to change said base address of said Address Offset device.

7. The partition apparatus, as recited in claim 3, further comprising a device to change the beginning address of said hard disk reserved section.

8. The partition apparatus, as in claim 2 or 3, further comprising a device to change the beginning address of said write-protection section at the back of said hard disk.

9. The partition apparatus, as in claims 2, 3 or 4, further comprising a device to change the end address of write-protection section in the front of said hard disk.

10. The partition apparatus, as recited in any preceding claim, being a combination of any one of said preceding claims.

11. The partition apparatus, as recited in claim 10, being positioned between a computer motherboard and said hard disk.

12. The partition apparatus, as recited in claim 10, being positioned in chipsets controlling and processing hard disk interface on a computer motherboard.

13. The partition apparatus, as recited in claim 10, being positioned in hard disk driver.

14. The partition apparatus, as recited in claim 10, further comprises an identity authentication device to prevent unauthorized access to said hard disk.

15. A method of realizing secured hard disk partition of a computer, comprising the steps of:
(a) resetting said computer and resetting one-way lockup device at the same time;
(b) setting a hard disk set address of user accessible section;
(c) setting said one-way lockup device; and
(d) booting OS of said computer.

16. The method, as recited in claim 15, in step (b), further comprising a step of validating a user's identity.

17. The method as in claim 14 or 15, in step (b), further comprising a step of presetting an alternative or combined sets of base address of a hard disk Address Offset, beginning address of a reserved section, beginning address of a write-protection section at the back of said hard disk, and end address of a write-protection section in the front of said hard disk.

18. The method, as recited in claim 17, wherein said base address of said hard disk Address Offset, said beginning address of said reserved section, said beginning address of said write-protection section at the back of said hard disk, and said end address of said write-protection section in the front of said hard disk are stored in CMOS.

19. The method, as recited in claim 17, wherein said base address of said hard disk Address Offset, said beginning address of said reserved section, said beginning address of said write-protection section at the back of said hard disk, and said end address of said write-protection section in the front of said hard disk are stored on said hard disk.

20. The method, as recited in claim 17, wherein said base address of said hard disk Address Offset, said beginning address of said reserved section, said beginning address of said write-protection section at the back of said hard disk, and said end address of said write-protection section in the front of said hard disk are arranged to be determined by the overall capacity of said hard disk.

21. The method, as recited in claim 17, wherein said base address of said hard disk Address Offset, said beginning address of said reserved section, said beginning address of said write-protection section at the back of said hard disk, and said end address of said write-protection section in the front of said hard disk are preset by a user every time when said computer is rebooted.

22. A booting method of realizing secured hard disk partition of a computer, comprising the steps of:
(a) powering on or resetting said computer and a one-way lockup device at the same time;
(b) after self-detection, reading system programs started at a nominated address on said hard disk or in hardware memory, and then transferring a control of said computer to said system programs;
(c) executing said system programs; and
(d) booting OS of said computer.

23. The booting method, as recited in claim 22, wherein said execution of said system programs includes:
(i) selecting to start OS, anti-virus, identity authentication, and network selection programs;
(ii) selecting to set a set addresses of Address Offset and user accessible section and offset address; and
(iii) setting said one-way lockup device.

24. An apparatus of realizing hard disk security strategy, comprising:
a password lockup device, wherein said password lockup device is a register device adapted to be reset with passwords or other identity authentication methods, wherein when said password lockup device is set, a current hard disk set address is locked up; and
a set address lock device, wherein according to a set state of said password lockup device, said set address lock device prohibits said hard disk to execute any commands able to change said hard disk set address.

25. The apparatus, as recited in claim 24, wherein said set address in said set address lock device comprises a combination of said base address of hard disk Address Offset, a beginning address of hard disk reserved section, a beginning address of write-protection section at the back of said hard disk, and an end address of write-protection section in the front of said hard disk.
